(19) United States
(12) Patent Application Publication
(10) Pub. No.: US 2018/0277134 A1
(43) Pub. Date: Sep. 27, 2018

(54) Key Click Suppression

(71) Applicant: Knowles Electronics, LLC, Itasca, IL (US)

(72) Inventors: Michael M. Goodwin, Scotts Valley, CA (US); John Woodruff, Palo Alto, CA (US); Carlos Avendano, Campbell, CA (US)

(21) Appl. No.: 14/745,176

(22) Filed: Jun. 19, 2015

Related U.S. Application Data
(60) Provisional application No. 62/019,345, filed on Jun. 30, 2014.

(51) Int. Cl. G10L 21/0208; G10L 25/30; G10L 19/012

(52) U.S. Cl. CPC G10L 21/0208; G10L 19/012; G10L 25/30

(57) ABSTRACT

Provided are systems and methods for suppressing key clicks in audio signals. An example method includes extracting features of an audio signal. The features are provided as inputs to a neural network. The neural network is trained to identify clicks in the audio signal and/or generate a multiplicative suppression mask suitable for removing key clicks from the audio signal. The suppression mask is applied to the audio signal to produce a clicks-removed audio signal. Comfort noise may be added to the clicks-removed audio signal to avoid noise pumping artifacts. The example method can be used without imposing keyboard activity restrictions on users. The key click suppression can be used in audio systems with a single microphone or with multiple microphones.

### CROSS-REFERENCE TO RELATED APPLICATION

The present application claims the benefit of U.S. Provisional Application No. 62/019,345, filed on Jun. 30, 2014. The subject matter of the aforementioned application is incorporated herein by reference for all purposes.

### FIELD

The present application relates generally to audio processing, and, more specifically, to systems and methods for suppressing key clicks.

### BACKGROUND

Note-taking and other input activities can result in key clicks corrupting a speech signal during teleconferences. The corruption of the speech signal can be quite strong if a device is being used for typing and voice communications concurrently. Due to the proximity of the microphone to the keyboard, the corruption can severely impair the speech signal. Existing method for suppressing the key clicks in audio signals are either ad hoc solutions or have other drawbacks.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for suppressing key clicks in an audio signal. An example method includes extracting features from the audio signal. The method allows determining, via a neural network, a key click suppression mask based on the extracted features and a click model. The method includes applying the key click suppression mask to the audio signal to generate a clicks-removed audio signal.

In some embodiments, the method includes generating a comfort noise based on the audio signal and combining the comfort noise and the clicks-removed audio signal to generate an output audio signal.

In certain embodiments, the method includes generalized training, via the neural network, for suppressing the key clicks in the audio signal on an arbitrary keyboard of an arbitrary device.

The method may include specific training, via the neural network, for a particular device based on a clicking characteristic thereof, including calibrating suppression for the particular device.

In some embodiments, the method includes calibrating the determining, via the neural network, based on key clicks specific to typing of a particular user on a keyboard or keypad. In certain embodiments method includes learning, via the neural network, particular characteristics of the keyboard or keypad and particular characteristics associated with a user. The user can be associated with the particular keyboard or keypad. In some embodiments, the learning occurs during otherwise quiet conditions.

The method may include adjusting or controlling parameters for key click suppression using auxiliary information. In various embodiments, the auxiliary information include one or more of the following: keystroke data from an operating system, data captured by input sensors configurable to register impacts, wherein the key clicks originating from a non-standard keyboard are suppressed based on the registered impacts. In certain embodiments, the input sensors comprise an accelerometer configurable to register the impacts.

In various embodiments, the method includes synchronizing the auxiliary information with acoustic information about the key clicks. The synchronized auxiliary information can be used for key click suppression on a per-stroke basis.

In some embodiments, the method includes detecting a period of inactivity of a user, such that no key clicks are detected based on the extracted features during the period, and halting application of the key click suppression mask during the detected period. In response to detection of key clicks signifying an end of the period of inactivity, applying the key click suppression mask can be continued. In certain embodiments, the halting of application of the key click suppression occurs during long periods of inactivity. The long periods include a period exceeding a predetermined time duration.

According to another example embodiment of the present disclosure, the steps of the method for suppressing key clicks in audio signal are stored on a machine-readable medium comprising instructions, which when implemented by one or more processors perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram of environment in which the present technology can be practiced.

FIG. 2 is a block diagram showing an example audio device suitable for implementing various embodiments of the present disclosure.

FIG. 3 is a diagram illustrating an audio processing system for suppressing key clicks in audio signals, according to an example embodiment.

FIG. 4 is a flow chart showing steps of a method for suppressing key clicks in audio signals, according to an example embodiment.

FIG. 5 is a computer system which can be used to implement methods for the present technology, according to an example embodiment.

### DETAILED DESCRIPTION

The technology disclosed herein relates to systems and methods for key click suppression in audio signal. Embodiments of present disclosure allow the suppression without diminishing quality of the audio signal, without imposing keyboard activity restrictions on a user. The technology described herein can be suitable for use with either single microphone or multi-microphone systems. Embodiments of the present disclosure can be practiced on any audio device configured to receive an audio signal. In some embodiments, audio devices can include notebook computers, tablet computers, phablets, smart phones, wearables, personal digital assistants, media players, mobile telephones, phone handsets, headsets, conferencing systems, and so on. While some embodiments of the present disclosure are described with reference to operation of a desktop or a notebook computer, it should be understood that the present disclosure may be practiced with any audio device.

Audio devices can include radio frequency (RF) receivers, transmitters, and transceivers, wired and/or wireless telecommunications and/or networking devices, amplifiers, audio and/or video players, encoders, decoders, speakers, inputs, outputs, storage devices, and user input devices. Audio devices can include input devices such as buttons, switches, keys, keyboards, trackballs, sliders, touchscreens, one or more microphones, gyroscopes, accelerometers, global positioning system (GPS) receivers, and the like. Audio devices can include outputs, such as LED indicators, video displays, touchscreens, speakers, and the like.

In various embodiments, the audio devices can be operated in stationary and portable environments. Stationary environments can include residential and commercial buildings or structures, and the like. For example, the stationary environments can include living rooms, bedrooms, home theaters, conference rooms, auditoriums, business premises, and the like. Portable environments can include moving vehicles, moving persons, other transportation means, and the like.

According to an example embodiment, a method for suppressing key clicks can include extracting features from the audio signal. The method can allow determining, via a neural network, a key click suppression mask based on the features and a click model. The method can include applying the key click suppression mask to the audio signal to generate a clicks-removed audio signal.

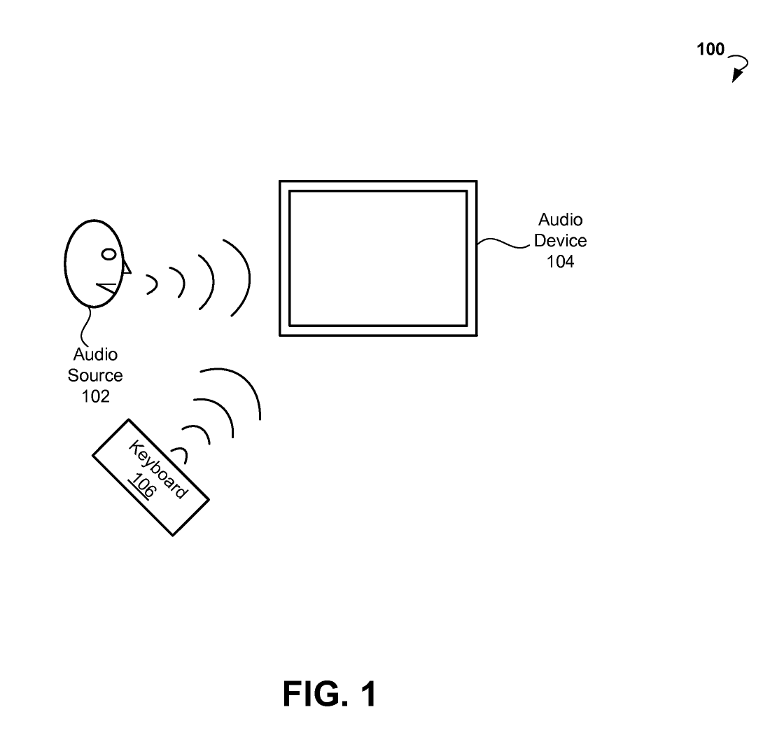

Referring now to FIG. 1, an exemplary environment 100 is shown in which a method for key click suppression can be practiced. The environment 100 can include an audio device 104 configurable to receive an audio signal.

In some embodiments, the audio device 104 includes at least one microphone operable to capture an acoustic sound from at least one audio source 102, for example, a person speaking into the microphone. In other embodiments, audio device 104 can be configurable to receive an audio signal Rx(t) from another device via an input jack or from a far-end source via a communications network, for example a radio, phone connection, cellular network, Internet, and the like. Alternatively, in some embodiments, the audio signal provided to the audio device 104 can be stored on a storage media such as a memory device, an integrated circuit, a CD, a DVD, and so forth.

The audio signal received by the audio device 104 can be contaminated by a noise. Noise is unwanted sound present in the environment 100 which may be captured by, for example, sensors such as microphones. Noise sources may include street noise, ambient noise, sound from a mobile device such as audio, speech from entities other than an intended speaker(s), and the like. In some embodiments, noise may include a button clicking sound resulting from typing on a keyboard 106. Thus, the acoustic signal Rx(t) can be represented as a superposition of a speech component s(t) and a noise component n(t).

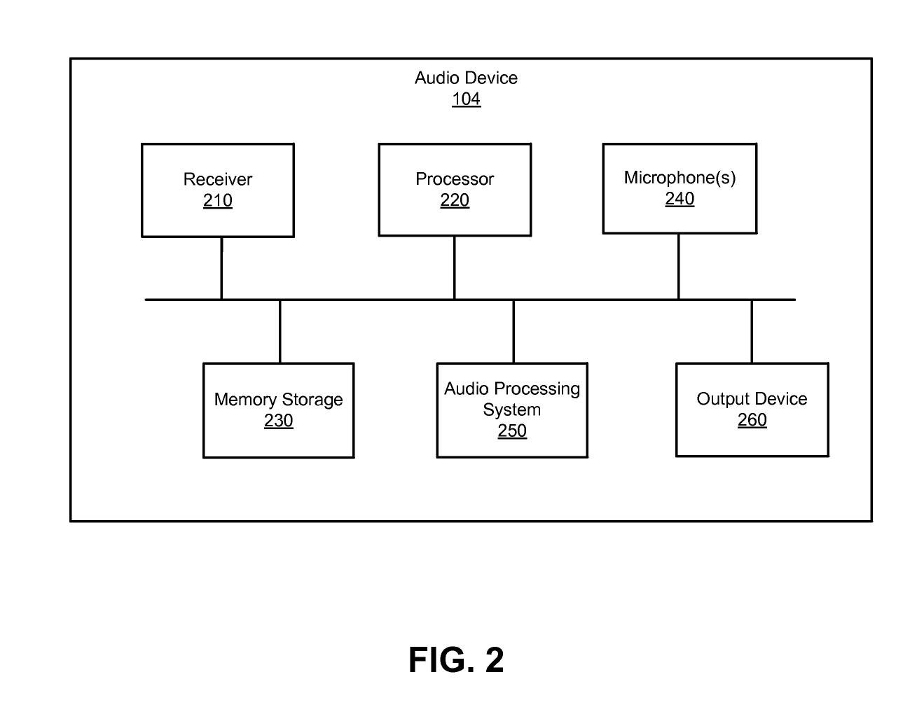

FIG. 2 is a block diagram showing components of audio device 104, according to an example embodiment. The audio device 104 can include a receiver 210, a processor 220, a memory storage 230, microphone(s) 240, an audio processing system 250, and an output device 260, such as an audio transducer.

The processor 220 of the audio device 104 can execute instructions and modules stored in a memory to perform functionality described herein, including key click suppression in the audio signal. In some embodiments, the processor 220 includes hardware and software implemented as a processing unit, which is operable to process floating point operations and other operations for the processor 220.

The receiver 210 can be configured to communicate with a network such as the Internet, Wide Area Network (WAN), Local Area Network (LAN), cellular network, and so forth, to receive audio data stream. The received audio data stream may be then forwarded to the audio processing system 250 and the output device 260.

In some embodiments, the audio processing system 250 includes hardware and software that implement the methods according to various embodiments disclosed herein. The audio processing system 250 can be further configured to receive acoustic signals from an acoustic source via microphone(s) 240 and process the acoustic signals.

In some embodiments, the audio device 104 includes multiple microphones, the multiple microphones being spaced a distance apart, such that the acoustic waves impinging on the device from certain directions exhibit different energy levels at the two or more microphones. After receipt by the microphone(s) 240, the acoustic signals can be converted into electric signals by an analog-to-digital converter.

In other embodiments, where the microphone(s) 240 are omni-directional microphones that are closely spaced (e.g., 1-2 cm apart), a beamforming technique can be used to simulate a forward-facing and backward-facing directional microphone response. A level difference can be obtained using the simulated forward-facing and backward-facing directional microphone. The level difference can be used to discriminate speech and noise in, for example, the time-frequency domain, which can be used in noise and/or echo reduction. In some embodiments, some microphones are used mainly to detect speech and other microphones are used mainly to detect noise. In various embodiments, some microphones are used to detect both noise and speech. In certain embodiments, the audio processing system 250 is configured to carry out noise suppression and/or noise reduction based on inter-microphone level difference, level salience, pitch salience, signal type classification, speaker identification, and so forth.

The output device 260 can include any device which provides an audio output to a listener (e.g., the acoustic source). For example, the output device 260 may comprise a speaker, a class-D output, an earpiece of a headset, or a handset on the audio device 104.

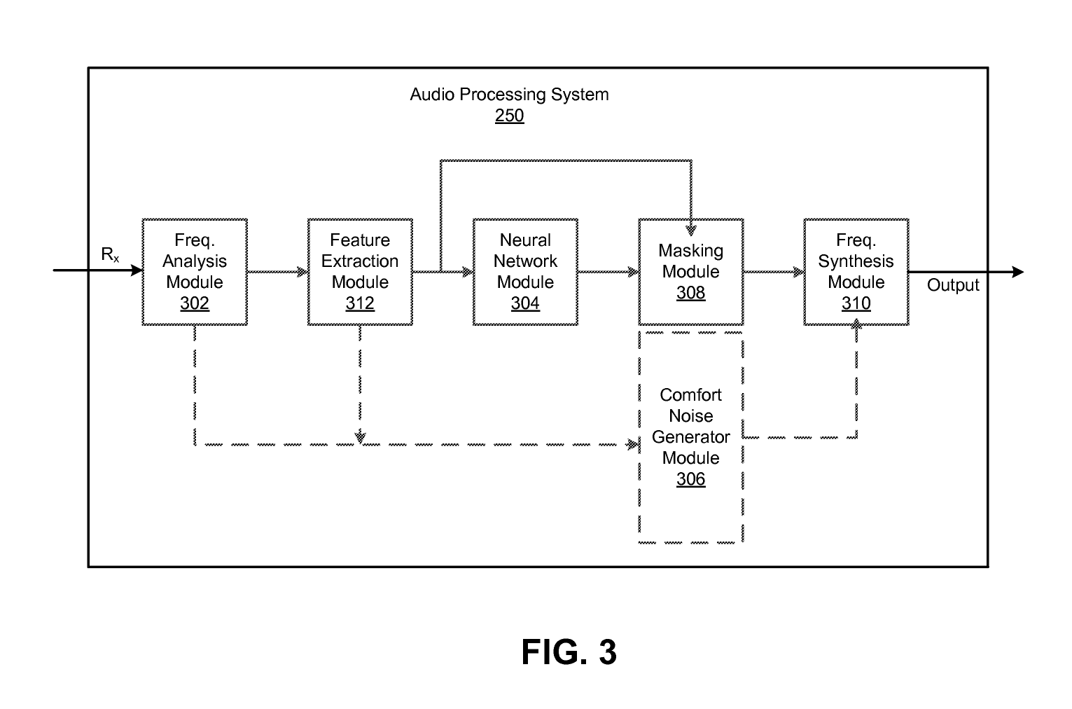

FIG. 3 illustrates an audio processing system 250 operable to suppress key clicks in audio signals, according to an example embodiment. The exemplary audio processing system 250 includes a frequency analysis module 302, a feature extraction module 312, a neural network module 304, a masking module 308, and frequency synthesis module 310. In addition, a comfort noise generator module 306 can be provided.

In some embodiments, the frequency analysis module 302 receives the audio signal, converts the audio signal to a time-frequency domain representation, and provides the representation to the feature extraction module 312. The feature extraction module 312 can be operable to extract one or more salient features associated with the audio signal. The salient features can include short-term energies, a transient model or characterization (onset detection), and a background noise estimate. The salient features can be further provided to the neural network module 304 and to the masking module 308.

In some embodiments, the neural network module 304 is trained to identify clicks in the time-frequency domain representation of the audio signal. In certain embodiments, the neural network module 304 outputs a multiplicative suppression mask suitable for removing the clicks in the time-frequency domain representation of the audio signal. The multiplicative suppression mask may be derived based on a click model. The neural network module 304 may employ machine learning to model key clicks. In some embodiments, the masking module 308 is operable to apply the multiplicative suppression mask to the audio signal (in the time-frequency domain representation) to remove the clicks. The clicks-removed audio signal can be provided to the frequency synthesis module 310.

Although the machine learning technique described herein is facilitated by a neural network module, in some other embodiments, other suitable machine learning modules can be used.

In some embodiments, the comfort noise generation module 306 generates comfort noise. The comfort noise can be shaped and added on a subband basis in order to avoid noise pumping artifacts. In some embodiments, the subbands are recombined with the clicks-removed audio signal by the frequency synthesis module 310 to form an output audio signal.

The audio device 104 may include a training application to train the audio processing system 250 to suppress key clicks by, for example, adjusting parameters of the neural network module 304. In some embodiments, diverse training can achieve generalization to arbitrary devices. For example, the audio processing system 250 can be trained to suppress the key clicks in the audio signal on an arbitrary keyboard.

In some embodiments, the parameters of neural network module 304 for key click suppression are calibrated based on a clicking characteristic of a particular keyboard. In addition, the calibration can be based on key click sounds that are specific to a person typing on the keyboard.

In some embodiments, the keyboard and/or typist specific training of the audio processing system 250 is performed under quiet conditions. While being trained under the quiet conditions, the exemplary audio processing system 250 can receive uncorrupted observations of the keystroke events, in various embodiments, which may lead to a higher-performance solution.

In some embodiments, the parameters of the audio processing system 250 for key click suppression are adjusted or controlled using auxiliary information. The auxiliary information can include keystroke data from an operating system, and/or data captured by input sensors, such as accelerometers configurable to register impacts. For example, the input sensors can be used when a typist uses a non-standard keyboard utilizing an impact-based input. In some embodiments, the auxiliary information is used on a per-stroke basis if the auxiliary information can be synchronized with the information of the acoustic click events picked up by the microphone(s) 240. In other embodiments, the auxiliary information is used to turn off the key click suppression during long periods of inactivity. The period of inactivity may be identified in response to key clicks not being detected, with the long period being a period exceeding a predetermined time duration.

In further embodiments, the audio processing system 250 for key click suppression is combined with other noise suppression/reduction modules. While the techniques described herein require an audio input only from a single microphone, these techniques can be integrated into noise suppression systems that require inputs from multiple microphones. In some embodiments, the audio processing system 250 for key click suppression can be incorporated into the receive path (denoted by Rx). For example, the audio processing system 250 can be implemented as an external computing device configurable to receive an audio signal via an Rx input and output the clicks-removed audio signal to an Rx output. In some embodiments, parameters of the audio processing system 250 for key click suppression can be calibrated remotely via a network.

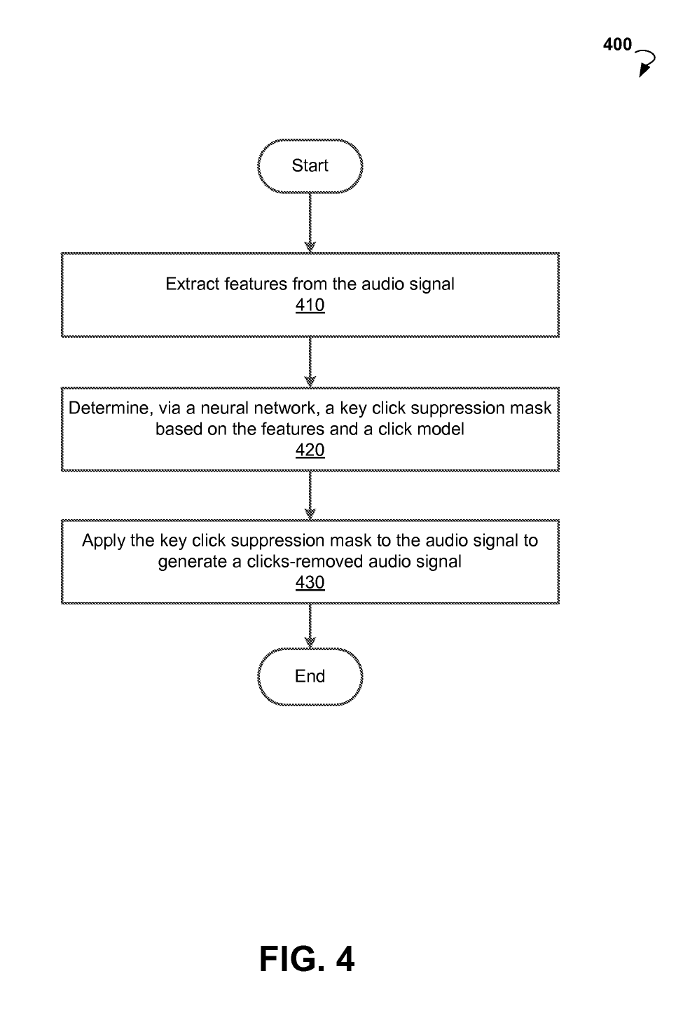

FIG. 4 is a flow chart of method 400 for suppressing key clicks in an audio signal, according to an example embodiment. The method 400 can be performed by the audio device 104 using audio processing system 250.

The method 400 can commence, at block 410, with extracting features from the audio signal. The audio signal can include a superposition of a speech component and a noise component. The noise component can include noise due to typing on a keyboard. At block 420, a key click suppression mask based on the features and a click model determining can be determined with a neural network. At block 430, the key click suppression mask can be applied to the audio signal to generate a clicks-removed audio signal.

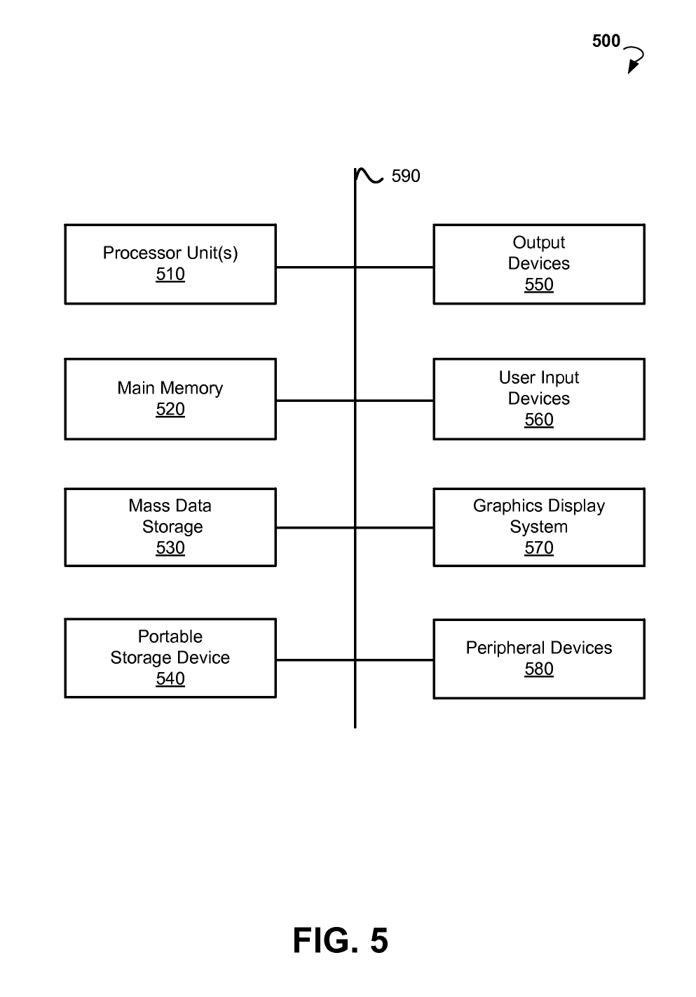

FIG. 5 illustrates an exemplary computer system 500 that may be used to implement some embodiments of the present invention. The computer system 500 of FIG. 5 may be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor units 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means. Processor unit 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system 500.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

1. A method for suppressing key clicks in an audio signal, the method comprising:
extracting features from an audio signal containing both key clicks and speech;
determining, via a neural network, a key click suppression mask based on the features and a click model;
applying the key click suppression mask to the audio signal to generate a clicks-removed audio signal, the clicks-removed audio signal containing the speech while sound from the key clicks in the audio signal has been substantially reduced by the key click suppression mask; and
calibrating the determining of the key click suppression mask based on key clicks specific to typing of a particular user on a keyboard or keypad, the calibrating including learning one or both of particular characteristics of the keyboard or keypad and particular characteristics associated with the particular user so as to update parameters of the neural network that are used to determine the key click suppression mask.

2. The method of claim 1, further comprising generating a comfort noise based on the audio signal, and combining the comfort noise and the clicks-removed audio signal to generate an output audio signal.

3. The method of claim 1, further comprising generalized training, via the neural network, for suppressing the key clicks in the audio signal on an arbitrary keyboard of an arbitrary device.

4-6. (canceled)

7. The method of claim 1, wherein the learning occurs during otherwise quiet conditions.

8. The method of claim 1, further comprising adjusting or controlling parameters for key click suppression using auxiliary information.

9. The method of claim 8, wherein the auxiliary information include one or more of the following: keystroke data from an operating system, data captured by input sensors configurable to register impacts, wherein the key clicks originating from a non-standard keyboard are suppressed based on the registered impacts.

10. The method of claim 9, wherein the input sensors comprise an accelerometer configurable to register the impacts.

11. The method of claim 9, further comprising synchronizing the auxiliary information with acoustic information concerning the key clicks; and using the synchronized auxiliary information for key click suppression on a per-stroke basis.

12. The method of claim 8, further comprising detecting a period of inactivity of a user, such that no key clicks are detected based on the features during the period, and halting applying the key click suppression mask during the detected period; and in response to detecting key clicks signifying an end of the period of inactivity, continuing application of the key click suppression mask.

13. The method of claim 12, wherein the halting of applying of the key click suppression occurs after a long period of inactivity, the long period of inactivity being a period exceeding a predetermined time duration.

14. A system for suppressing key clicks in an audio signal, the system comprising:
a processor; and
a memory communicatively coupled with the processor, the memory storing instructions which when executed by the processor performs a method comprising:
extracting features from an audio signal containing both key clicks and speech;
determining, via a neural network, a key click suppression mask based on the features and a click model;
applying the key click suppression mask to the audio signal to generate a clicks-removed audio signal, the clicks-removed audio signal containing the speech while sound from the key clicks in the audio signal has been substantially reduced by the key click suppression mask; and
calibrating the determining of the key click suppression mask based on key clicks specific to typing of a particular user on a keyboard or keypad, the calibrating including learning one or both of particular characteristics of the keyboard or keypad and particular characteristics associated with the particular user so as to update parameters of the neural network that are used to determine the key click suppression mask.

15. The system of claim 14, wherein the method further comprises:
generating a comfort noise based on the audio signal, and combining the comfort noise and the clicks-removed audio signal to generate an output audio signal; and
generalized training, via the neural network, for suppressing the key clicks in the audio signal on an arbitrary keyboard of an arbitrary device.

16. (canceled)

17. The system of claim 14, wherein the method further comprises:
adjusting or controlling parameters for key click suppression using auxiliary information, the auxiliary information including one or more of the following: keystroke data from an operating system, data captured by input sensors configurable to register impacts, wherein the key clicks originating from a non-standard keyboard are suppressed based on the registered impacts and the input sensors comprise an accelerometer configurable to register the impacts; and
synchronizing the auxiliary information with acoustic information about the key clicks; and
using the synchronized auxiliary information for key click suppression on a per-stroke basis.

18. The system of claim 17, wherein the input sensors comprise an accelerometer configurable to register the impacts.

19. The system of claim 14, wherein the method further comprises:
adjusting or controlling parameters for key click suppression using auxiliary information;
detecting a period of inactivity of a user, such that no key clicks are detected based on the features during the period, and halting applying the key click suppression mask during the detected period; and
in response to detecting key clicks signifying an end of the period of inactivity, continuing application of the key click suppression mask.

20. A non-transitory computer-readable storage medium having embodied thereon instructions, which when executed by one or more processors, perform steps of a method for suppressing key clicks in an audio signal, the method comprising:
extracting features from an audio signal containing both key clicks and speech;
determining, via a neural network, a key click suppression mask based on the features and a click model;
applying the key click suppression mask to the audio signal to generate a clicks-removed audio signal, the clicks-removed audio signal containing the speech while sound from the key clicks in the audio signal has been substantially reduced by the key click suppression mask; and
calibrating the determining of the key click suppression mask based on key clicks specific to typing of a particular user on a keyboard or keypad, the calibrating including learning one or both of particular characteristics of the keyboard or keypad and particular characteristics associated with the particular user so as to update parameters of the neural network that are used to determine the key click suppression mask.

21. The method of claim 2, wherein generating the comfort noise is performed on a sub-band basis and wherein combining is also performed on a sub-band basis using frequency synthesis.

22. The system of claim 15, wherein generating the comfort noise is performed on a sub-band basis and wherein combining is also performed on a sub-band basis using frequency synthesis.

23. The non-transitory computer-readable storage medium of claim 20, wherein the method further comprises:
generating a comfort noise based on the audio signal, and combining the comfort noise and the clicks-removed audio signal to generate an output audio signal,
wherein generating the comfort noise is performed on a sub-band basis and wherein combining is also performed on a sub-band basis using frequency synthesis.

24. The method of claim 1, wherein applying the key click suppression mask includes multiplying the key click suppression mask with a time-frequency domain representation of the audio signal.
